(19) United States
(12) Patent Application Publication
(10) Pub. No.: US 2011/0103510 A1
(43) Pub. Date: May 5, 2011

(54) RANK AND PRECODING INDICATION FOR MIMO OPERATION

(75) Inventors: Peter Gaal, San Diego, CA (US); Xiaoxia Zhang, San Diego, CA (US); Wanshi Chen, San Diego, CA (US); Xiliang Luo, San Diego, CA (US); Juan Montojo, San Diego, CA (US)

(73) Assignee: QUALCOMM INCORPORATED, San Diego, CA (US)

(21) Appl. No.: 12/765,797

(22) Filed: Apr. 22, 2010

Related U.S. Application Data
(60) Provisional application No. 61/172,145, filed on Apr. 23, 2009.

(51) Int. Cl. H04L 27/00

(52) U.S. Cl. 375/295; 375/316

(57) ABSTRACT

Certain aspects of the present disclosure relate to a technique for signaling rank and precoding indications in uplink and downlink MIMO operations using codebook and non-codebook based precoding.

### CLAIM OF PRIORITY UNDER 35 U.S.C. §119

The present application for patent claims benefit of Provisional Application Ser. No. 61/172,145 filed Apr. 23, 2009 and assigned to the assignee hereof and hereby expressly incorporated by reference herein.

### BACKGROUND

1. Field

Certain aspects of the present disclosure generally relate to wireless communications and, more particularly, to a method for reporting channel feedback at an access point for uplink transmissions.

2. Background

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include Code Division Multiple Access (CDMA) systems, Time Division Multiple Access (TDMA) systems, Frequency Division Multiple Access (FDMA) systems, 3^{rd} Generation Partnership Project (3GPP) Long Term Evolution (LTE) systems, and Orthogonal Frequency Division Multiple Access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-input single-output, multiple-input single-output or a multiple-input multiple-output (MIMO) system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

A MIMO system supports a time division duplex (TDD) and frequency division duplex (FDD) systems. In a TDD system, the forward and reverse link transmissions are on the same frequency region so that the reciprocity principle allows the estimation of the forward link channel from the reverse link channel. This enables the access point to extract transmit beamforming gain on the forward link when multiple antennas are available at the access point.

In LTE, MIMO systems can be employed for transmit diversity, beamforming, spatial multiplexing, and the like. While such MIMO operations can typically be employed on downlink transmissions from an AP to an AT, advanced communication systems such as LTE-Advanced contemplate employing MIMO operations on the uplink as well. Thus, there is a need for techniques for communicating signaling for uplink MIMO operations.

### SUMMARY

Certain aspects provide a method for communicating signaling for uplink transmissions. The method generally includes jointly coding at least one rank indication (RI) and at least one precoding matrix indicator (PMI) using a codebook, and transmitting the jointly encoded RI and PMI to an access terminal.

Certain aspects provide a method for communicating signaling for uplink transmissions. The method generally includes receiving a jointly encoded rank indication (RI) and a precoding matrix indicator (PMI), decoding the jointly encoded RI and PMI using a codebook to determine a RI and a PMI, and using the determined RI and PMI in uplink transmissions.

Certain aspects provide a method of communicating signaling for uplink transmissions. The method generally includes generating an unprecoded reference signal (RS), including rank indication (RI) in a channel transmission, and transmitting the RS and the channel transmission to an access terminal.

Certain aspects provide a method of communicating signaling for uplink transmissions. The method generally includes receiving an unprecoded reference signal (RS), receiving a channel transmission comprising a rank indication (RI), detecting the PMI from the received RS, detecting the RI from the received channel transmission, and utilize detected PMI and RI in uplink transmissions.

Certain aspects provide a method of communicating signaling for downlink transmissions. The method generally includes generating a user equipment- (UE-) specific reference signal (RS) comprising a precoding matrix indicator (PMI), including a rank indication (RI) in a channel transmission, transmitting the UE-specific RS and the channel transmission to an access terminal.

Certain aspects provide a method of communicating signaling for downlink transmissions. The method generally includes receiving a user equipment- (UE-) specific reference signal (RS) comprising a precoding matrix indicator (PMI), receiving a channel transmission comprising a rank indication (RI), detecting the PMI from the received UE-specific RS, detecting the RI from the received channel transmission, and utilizing the detected PMI and RI in uplink transmissions.

Certain aspects provide an apparatus for wireless communications. The apparatus generally includes logic for jointly coding at least one rank indication (RI) and at least one precoding matrix indicator (PMI) using a codebook, and logic for transmitting the jointly encoded RI and PMI to an access terminal.

Certain aspects provide an apparatus for wireless communications. The apparatus generally includes logic for receiving a jointly encoded rank indication (RI) and a precoding matrix indicator (PMI), logic for decoding the jointly encoded RI and PMI using a codebook to determine a RI and a PMI, and logic for using the determined RI and PMI in uplink transmissions.

Certain aspects provide an apparatus for wireless communications. The apparatus generally includes logic for generating an unprecoded reference signal (RS), logic for including rank indication (RI) in a channel transmission, and logic for transmitting the unprecoded RS and the channel transmission to an access terminal.

Certain aspects provide an apparatus for wireless communications. The apparatus generally includes logic for receiving an unprecoded reference signal (RS), logic for receiving a channel transmission comprising a rank indication (RI), logic for determining a precoding matrix indicator (PMI) from the received unprecoded RS, logic for detecting the RI from the received channel transmission, and logic for using the determined PMI and the detected RI in uplink transmissions.

Certain aspects provide an apparatus for wireless communications. The apparatus generally includes logic for generating a user equipment- (UE-) specific reference signal (RS) comprising a precoding matrix indicator (PMI), logic for including a rank indication (RI) in a channel transmission, and logic for transmitting the UE-specific RS and the channel transmission to an access terminal.

Certain aspects provide an apparatus for wireless communications. The apparatus generally includes logic for receiving a user equipment- (UE-) specific reference signal (RS) comprising a precoding matrix indicator (PMI), logic for receiving a channel transmission comprising a rank indication (RI), logic for detecting the PMI from the received UE-specific RS, logic for detecting the RI from the received channel transmission, and logic for utilizing the detected PMI and RI in uplink transmissions.

Certain aspects provide an apparatus for wireless communications. The apparatus generally includes means for jointly coding at least one rank indication (RI) and at least one precoding matrix indicator (PMI) using a codebook, and means for transmitting the jointly encoded RI and PMI to an access terminal.

Certain aspects provide an apparatus for wireless communications. The apparatus generally includes means for receiving a jointly encoded rank indication (RI) and a precoding matrix indicator (PMI), means for decoding the jointly encoded RI and PMI using a codebook to determine a RI and a PMI, and means for using the determined RI and PMI in uplink transmissions.

Certain aspects provide an apparatus for wireless communications. The apparatus generally includes means for generating an unprecoded reference signal (RS), means for including rank indication (RI) in a channel transmission, and means for transmitting the unprecoded RS and the channel transmission to an access terminal.

Certain aspects provide an apparatus for wireless communications. The apparatus generally includes means for receiving an unprecoded reference signal (RS), means for receiving a channel transmission comprising a rank indication (RI), means for determining a precoding matrix indicator (PMI) from the received unprecoded RS, means for detecting the RI from the received channel transmission, and means for using the determined PMI and the detected RI in uplink transmissions.

Certain aspects provide an apparatus for wireless communications. The apparatus generally includes means for generating a user equipment- (UE-) specific reference signal (RS) comprising a precoding matrix indicator (PMI), means for including a rank indication (RI) in a channel transmission, and means for transmitting the UE-specific RS and the channel transmission to an access terminal.

Certain aspects provide an apparatus for wireless communications. The apparatus generally includes means for receiving a user equipment- (UE-) specific reference signal (RS) comprising a precoding matrix indicator (PMI), means for receiving a channel transmission comprising a rank indication (RI), means for detecting the PMI from the received UE-specific RS, means for detecting the RI from the received channel transmission, and means for utilizing the detected PMI and RI in uplink transmissions.

Certain aspects provide a computer-program product for wireless communications, comprising a computer readable medium having instructions stored thereon, the instructions being executable by one or more processors. The instructions generally include instructions for jointly coding at least one rank indication (RI) and at least one precoding matrix indicator (PMI) using a codebook, and instructions for transmitting the jointly encoded RI and PMI to an access terminal.

Certain aspects provide a computer-program product for wireless communications, comprising a computer readable medium having instructions stored thereon, the instructions being executable by one or more processors. The instructions generally include instructions for receiving a jointly encoded rank indication (RI) and a precoding matrix indicator (PMI), instructions for decoding the jointly encoded RI and PMI using a codebook to determine a RI and a PMI, and instructions for using the determined RI and PMI in uplink transmissions.

Certain aspects provide a computer-program product for wireless communications, comprising a computer readable medium having instructions stored thereon, the instructions being executable by one or more processors. The instructions generally include instructions for generating an unprecoded reference signal (RS), instructions for including rank indication (RI) in a channel transmission, and instructions for transmitting the unprecoded RS and the channel transmission to an access terminal.

Certain aspects provide a computer-program product for wireless communications, comprising a computer readable medium having instructions stored thereon, the instructions being executable by one or more processors. The instructions generally include instructions for receiving an unprecoded reference signal (RS), instructions for receiving a channel transmission comprising a rank indication (RI), instructions for determining a precoding matrix indicator (PMI) from the received unprecoded RS, instructions for detecting the RI from the received channel transmission, and instructions for using the determined PMI and the detected RI in uplink transmissions.

Certain aspects provide a computer-program product for wireless communications, comprising a computer readable medium having instructions stored thereon, the instructions being executable by one or more processors. The instructions generally include instructions for generating a user equipment- (UE-) specific reference signal (RS) comprising a precoding matrix indicator (PMI), instructions for including a rank indication (RI) in a channel transmission, and instructions for transmitting the UE-specific RS and the channel transmission to an access terminal.

Certain aspects provide a computer-program product for wireless communications, comprising a computer readable medium having instructions stored thereon, the instructions being executable by one or more processors. The instructions generally include instructions for receiving a user equipment- (UE-) specific reference signal (RS) comprising a precoding matrix indicator (PMI), instructions for receiving a channel transmission comprising a rank indication (RI), instructions for detecting the PMI from the received UE-specific RS, instructions for detecting the RI from the received channel transmission, and instructions for utilizing the detected PMI and RI in uplink transmissions.

Certain aspects provide an apparatus for wireless communications. The apparatus generally includes at least one processor configured to jointly code at least one rank indication (RI) and at least one precoding matrix indicator (PMI) using a codebook, and transmit the jointly encoded RI and PMI to an access terminal; and a memory coupled to the at least one processor.

Certain aspects provide an apparatus for wireless communications. The apparatus generally includes at least one processor configured to receive a jointly encoded rank indication (RI) and a precoding matrix indicator (PMI), decode the jointly encoded RI and PMI using a codebook to determine a RI and a PMI, and use the determined RI and PMI in uplink transmissions; and a memory coupled to the at least one processor.

Certain aspects provide an apparatus for wireless communications. The apparatus generally includes at least one processor configured to generate an unprecoded reference signal (RS), include rank indication (RI) in a channel transmission, and transmit the unprecoded RS and the channel transmission to an access terminal; and a memory coupled to the at least one processor.

Certain aspects provide an apparatus for wireless communications. The apparatus generally includes at least one processor configured to receive an unprecoded reference signal (RS), receive a channel transmission comprising a rank indication (RI), determine a precoding matrix indicator (PMI) from the received unprecoded RS, detect the RI from the received channel transmission, and using the determined PMI and the detected RI in uplink transmissions; and a memory coupled to the at least one processor.

Certain aspects provide an apparatus for wireless communications. The apparatus generally includes at least one processor configured to generate a user equipment- (UE-) specific reference signal (RS) comprising a precoding matrix indicator (PMI), include a rank indication (RI) in a channel transmission, and transmit the UE-specific RS and the channel transmission to an access terminal; and a memory coupled to the at least one processor.

Certain aspects provide an apparatus for wireless communications. The apparatus generally includes at least one processor configured to receive a user equipment- (UE-) specific reference signal (RS) comprising a precoding matrix indicator (PMI), receive a channel transmission comprising a rank indication (RI), detect the PMI from the received UE-specific RS, detect the RI from the received channel transmission, and utilize the detected PMI and RI in uplink transmissions; and a memory coupled to the at least one processor.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates an example multiple access wireless communication system in accordance with certain aspects of the present disclosure.

FIG. 2 illustrates a block diagram of an access point and a user terminal in accordance with certain aspects of the present disclosure.

FIG. 3 illustrates various components that may be utilized in a wireless device in accordance with certain aspects of the present disclosure.

FIG. 4 illustrates example operations that may be performed at an access point for communicating signaling in accordance with certain aspects of the present disclosure.

FIG. 5 illustrates example operations that may be performed at an access terminal for communicating signaling in accordance with certain aspects of the present disclosure.

FIG. 6 illustrates example operations that may be performed at an access point for communicating signaling in accordance with certain aspects of the present disclosure.

FIG. 7 illustrates an example operation that may be performed at an access terminal in accordance with certain aspects of the present disclosure.

FIG. 8 illustrates an example operation that may be performed at an access point in accordance with certain aspects of the present disclosure.

FIG. 9 illustrates example operations that may be performed at an access terminal in accordance with certain aspects of the present disclosure.

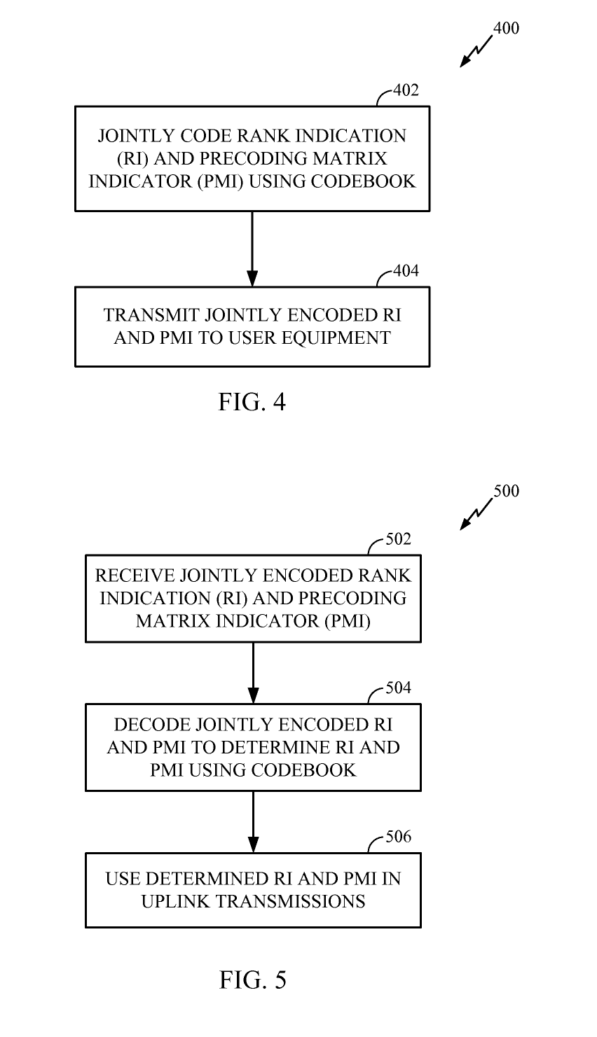

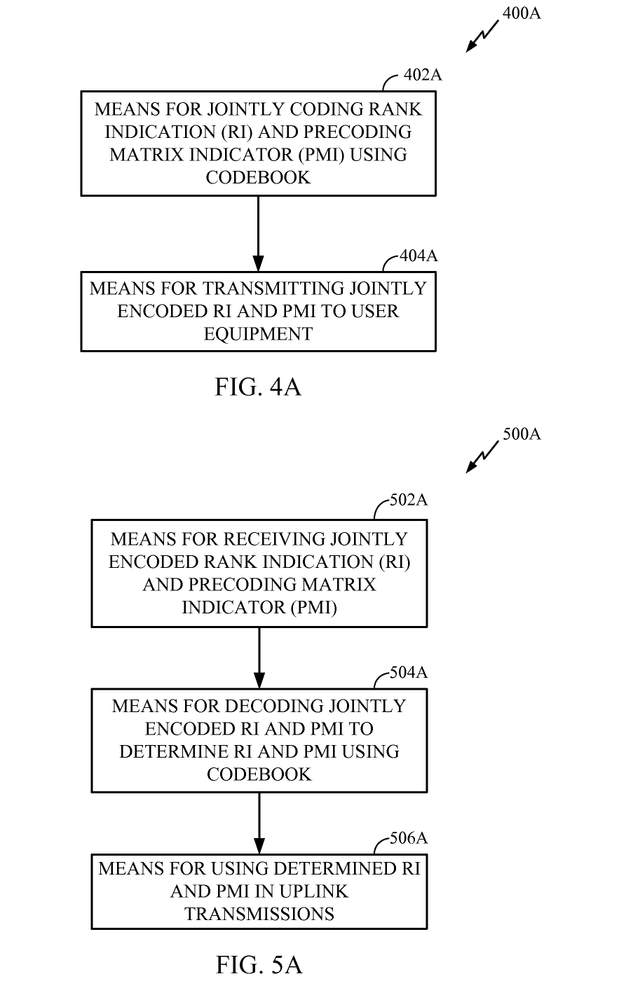

FIGS. 4A, 5A, 6A, 7A, 8A, and 9A illustrate example components capable of performing operations shown in FIGS. 4, 5, 6, 7, 8, and 9.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### An Example Wireless Communication System

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), CDMA2000, etc. UTRA includes Wideband-CDMA (W-CDMA) and Low Chip Rate (LCR). CDMA2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS and LTE are described in documents from an organization named “3rd Generation Partnership Project” (3GPP). CDMA2000 is described in documents from an organization named “3rd Generation Partnership Project 2” (3GPP2).

Single carrier frequency division multiple access (SC-FDMA) is a transmission technique that utilizes single carrier modulation at a transmitter side and frequency domain equalization at a receiver side. The SC-FDMA has similar performance and essentially the same overall complexity as those of OFDMA system. However, SC-FDMA signal has lower peak-to-average power ratio (PAPR) because of its inherent single carrier structure. The SC-FDMA has drawn great attention, especially in the uplink communications where lower PAPR greatly benefits the mobile terminal in terms of transmit power efficiency. It is currently a working assumption for uplink multiple access scheme in the 3GPP LTE and the Evolved UTRA.

An access point (“AP”) may comprise, be implemented as, or known as NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

An access terminal (“AT”) may comprise, be implemented as, or known as an access terminal, a subscriber station, a subscriber unit, a mobile station, a remote station, a remote terminal, a user terminal, a user agent, a user device, user equipment (“UE”), a user station, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium. In some aspects the node is a wireless node. Such wireless node may provide, for example, connectivity for or to a network (e.g., a wide area network such as the Internet or a cellular network) via a wired or wireless communication link.

Referring to FIG. 1, a multiple access wireless communication system according to one aspect is illustrated. An access point 100 (AP) may include multiple antenna groups, one group including antennas 104 and 106, another group including antennas 108 and 110, and an additional group including antennas 112 and 114. In FIG. 1, only two antennas are shown for each antenna group, however, more or fewer antennas may be utilized for each antenna group. Access terminal 116 (AT) may be in communication with antennas 112 and 114, where antennas 112 and 114 transmit information to access terminal 116 over forward link 120 and receive information from access terminal 116 over reverse link 118. Access terminal 122 may be in communication with antennas 106 and 108, where antennas 106 and 108 transmit information to access terminal 122 over forward link 126 and receive information from access terminal 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access point. In one aspect of the present disclosure each antenna group may be designed to communicate to access terminals in a sector of the areas covered by access point 100.

In communication over forward links 120 and 126, the transmitting antennas of access point 100 may utilize beamforming in order to improve the signal-to-noise ratio of forward links for the different access terminals 116 and 124. Also, an access point using beamforming to transmit to access terminals scattered randomly through its coverage causes less interference to access terminals in neighboring cells than an access point transmitting through a single antenna to all its access terminals.

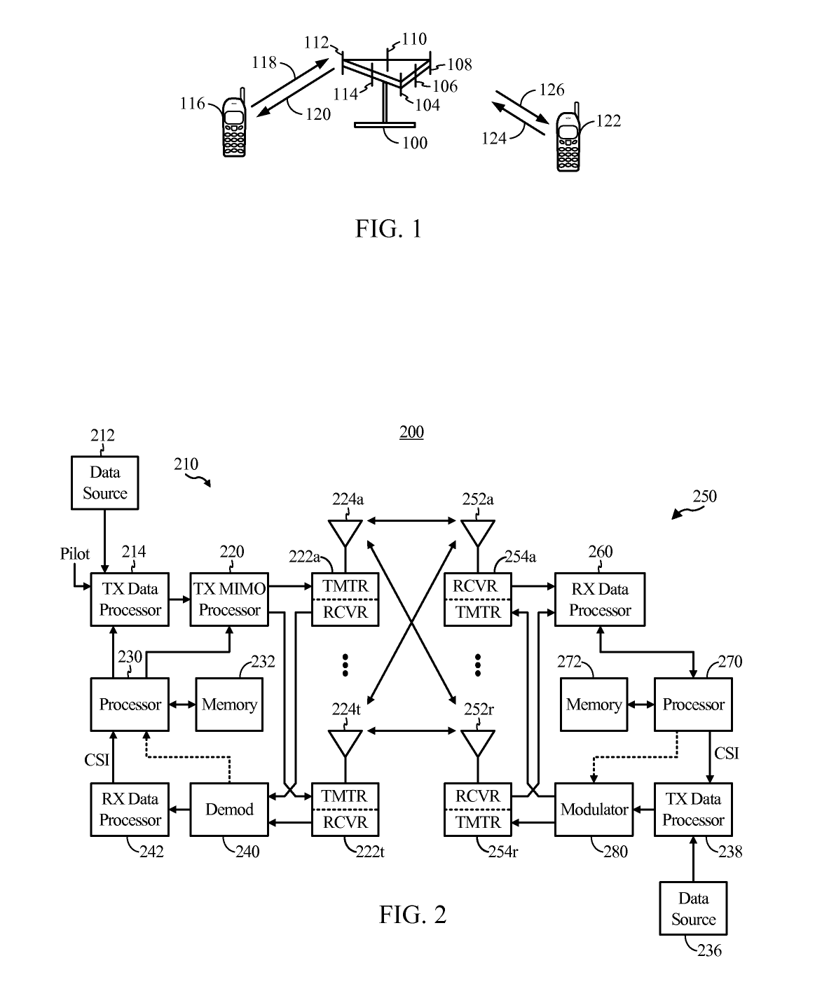

FIG. 2 illustrates a block diagram of an aspect of a transmitter system 210 (also known as the access point) and a receiver system 250 (also known as the access terminal) in a multiple-input multiple-output (MIMO) system 200. At the transmitter system 210, traffic data for a number of data streams is provided from a data source 212 to a transmit (TX) data processor 214.

In one aspect of the present disclosure, each data stream may be transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain aspects of the present disclosure, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals may be received by N_{R} antennas 252a through 252r and the received signal from each antenna 252 may be provided to a respective receiver (RCVR) 254a through 254r. Each receiver 254 may condition (e.g., filters, amplifies, and downconverts) a respective received signal, digitize the conditioned signal to provide samples, and further process the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 may be complementary to that performed by TX MIMO processor 220 and TX data processor 214 at transmitter system 210.

A processor 270 periodically determines which pre-coding matrix to use. Processor 270 formulates a reverse link message comprising a matrix index portion and a rank value portion. The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights, and then processes the extracted message.

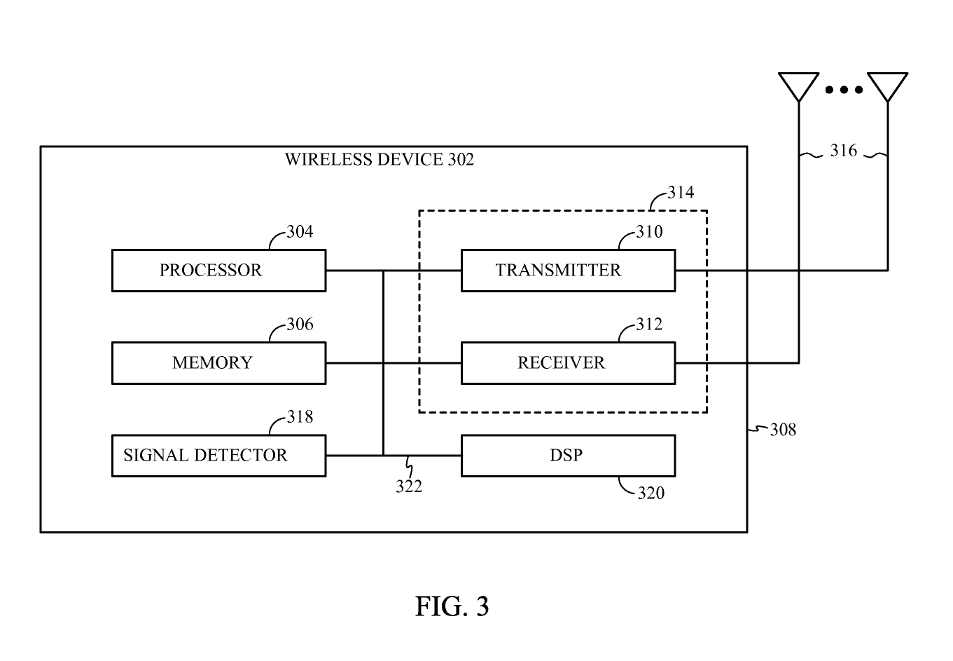

FIG. 3 illustrates various components that may be utilized in a wireless device 302 that may be employed within the wireless communication system illustrated in FIG. 1. The wireless device 302 is an example of a device that may be configured to implement the various methods described herein. The wireless device 302 may be a base station 100 or any of user terminals 116 and 122.

The wireless device 302 may include a processor 304 which controls operation of the wireless device 302. The processor 304 may also be referred to as a central processing unit (CPU). Memory 306, which may include both read-only memory (ROM) and random access memory (RAM), provides instructions and data to the processor 304. A portion of the memory 306 may also include non-volatile random access memory (NVRAM). The processor 304 typically performs logical and arithmetic operations based on program instructions stored within the memory 306. The instructions in the memory 306 may be executable to implement the methods described herein.

The wireless device 302 may also include a housing 308 that may include a transmitter 310 and a receiver 312 to allow transmission and reception of data between the wireless device 302 and a remote location. The transmitter 310 and receiver 312 may be combined into a transceiver 314. A single or a plurality of transmit antennas 316 may be attached to the housing 308 and electrically coupled to the transceiver 314. The wireless device 302 may also include (not shown) multiple transmitters, multiple receivers, and multiple transceivers.

The wireless device 302 may also include a signal detector 318 that may be used in an effort to detect and quantify the level of signals received by the transceiver 314. The signal detector 318 may detect such signals as total energy, energy per subcarrier per symbol, power spectral density and other signals. The wireless device 302 may also include a digital signal processor (DSP) 320 for use in processing signals.

The various components of the wireless device 302 may be coupled together by a bus system 322, which may include a power bus, a control signal bus, and a status signal bus in addition to a data bus.

In one aspect of the present disclosure, logical wireless communication channels may be classified into control channels and traffic channels. Logical control channels may comprise a Broadcast Control Channel (BCCH) which is a downlink (DL) channel for broadcasting system control information. A Paging Control Channel (PCCH) is a DL logical control channel that transfers paging information. A Multicast Control Channel (MCCH) is a point-to-multipoint DL logical control channel used for transmitting Multimedia Broadcast and Multicast Service (MBMS) scheduling and control information for one or several Multicast Traffic Channels (MTCHs). Generally, after establishing Radio Resource Control (RRC) connection, the MCCH may be only used by user terminals that receive MBMS. A Dedicated Control Channel (DCCH) is a point-to-point bi-directional logical control channel that transmits dedicated control information and it is used by user terminals having an RRC connection. Logical traffic channels may comprise a Dedicated Traffic Channel (DTCH) which is a point-to-point bi-directional channel dedicated to one user terminal for transferring user information. Furthermore, logical traffic channels may comprise a Multicast Traffic Channel (MTCH), which is a point-to-multipoint DL channel for transmitting traffic data.

Transport channels may be classified into DL and UL channels. DL transport channels may comprise a Broadcast Channel (BCH), a Downlink Shared Data Channel (DL-SDCH) and a Paging Channel (PCH). The UL transport channels may comprise a Random Access Channel (RACH), a Request Channel (REQCH), an Uplink Shared Data Channel (UL-SDCH) and a plurality of PHY channels.

The PHY channels may comprise a set of DL channels and UL channels. The DL PHY channels may comprise: Common Pilot Channel (CPICH), Synchronization Channel (SCH), Common Control Channel (CCCH), Shared DL Control Channel (SDCCH), Multicast Control Channel (MCCH), Shared UL Assignment Channel (SUACH), Acknowledgement Channel (ACKCH), DL Physical Shared Data Channel (DL-PSDCH), UL Power Control Channel (UPCCH), Paging Indicator Channel (PICH), and Load Indicator Channel (LICH). The UL PHY Channels may comprise: Physical Random Access Channel (PRACH), Channel Quality Indicator Channel (CQICH), Acknowledgement Channel (ACKCH), Antenna Subset Indicator Channel (ASICH), Shared Request Channel (SREQCH), UL Physical Shared Data Channel (UL-PSDCH), and Broadband Pilot Channel (BPICH).

### Rank and Precoding Indication for LTE-A MIMO Operation

In LTE, multiple transmit antenna schemes can be employed for transmit diversity, beamforming, spatial multiplexing, and the like. While such MIMO operations can typically be employed on downlink transmissions from an AP to an AT, advanced communication systems such as LTE-Advanced contemplate employing MIMO operations on the uplink as well. According to certain aspects, uplink MIMO operations can be similar to downlink MIMO operations of LTE. For example, uplink MIMO can employ a similar codeword-to-layer mapping as downlink MIMO as specified in LTE Rel-8. In another example, spatial bundling of hybrid automatic repeat request (HARQ) parameters can be utilized. For example, a single shared downlink acknowledgement/non-acknowledgement may be employed on a Physical HARQ Indicator Channel (PHICH), as well as a shared new data indicator (NDI) and redundancy version (RV). In another example, one or two modulation and coding scheme (MDS) fields can be employed. Layer shifting in the time domain may also be employed.

According to certain aspects, uplink MIMO operations may employ precoding. For a system employing a frequency division duplex (FDD) scheme, codebook-based precoding may be utilized. In one example, a single transmitted precoding matrix indicator (PMI) may be utilized per uplink component carrier. When used in uplink MIMO operations, a PMI is an indication of a preferred precoding matrix to be used in an AT for a given radio condition. A PMI may refer to a codebook table. In one aspect, a size-1 codebook with identity precoding may be utilized for full-rank transmissions. In another aspect, dynamic rank adaptation may be employed. For a MIMO system with a two antenna configuration, a codebook having 7 entries for layers 1 and 2 may be employed. For a MIMO system with a four antenna configuration, a codebook having 64 entries or less may be used. As the total size of the entries in the codebook is 8 for a two-transmitter configuration and less than 64 (i.e. a 6-bit codebook) for a four-antenna configuration, it can be deduced that a rank indicator (RI) may be indicated together with the PMI. It is appreciated that multiple PMIs may be utilized; frequency-selective precoding in a component carrier may be utilized.

FIG. 4 illustrates example operations 400 that may be performed at an AP for communicating channel feedback to an AT for uplink transmissions in accordance with certain aspects of the present disclosure. At 402, an AP may jointly code a rank indication (RI) and a precoding matrix indicator (PMI) using a codebook. In one aspect, a RI and a PMI are jointly coded using any suitable means, for example, through concatenation of RI and PMI. At 404, the AP may transmit the jointly encoded and PMI to the AT.

FIG. 5 illustrates an example operation 500 that may be performed at an AT for communicating channel feedback for uplink transmissions. At 502, the AT may receive a jointly encoded RI and PMI. At 504, the AT may decode the received jointly encoded RI and PMI to determine the RI and the PMI using a codebook. At 506, the AT may use the determined RI and PMI for uplink transmissions.

It is contemplated that rank indication with code-book based precoding in uplink transmissions may comprise several approaches. In one aspect, a single PMI and a single RI may be encoded per component carrier. The RI may be jointly coded with the PMI, wherein the PMI indicates the RI and the associated precoding vector/matrix per component carrier. Where multiple component carriers are employed, multiple PMIs may be used to signal the PMI and the RI on each component carrier. This scenario includes the special case where a single PMI is applied to all component carriers.

Performance may be gained by assuming some commonality between component carriers. According to certain aspects, multiple PMIs and a single rank may be employed per component carrier. The RI is jointly encoded with a PMI, wherein the PMI indicates the rank and the associated precoding vector/matrix. It is acknowledged that this approach may result in redundant signaling of rank. To reduce overhead caused by this approach, differential PMI signaling may be employed. In one aspect, RI may be signaled individually while PMI may signal a precoder index with the associated rank. However, when the number of precoders per rank is not the same, the required number of bits may be determined by a worst case scenario.

According to certain aspects, a single PMI may be signaled per component carrier while a single RI may be used across all component carriers. The RI is jointly coded with the PMI per component carrier, wherein the PMI indicates the RI and the associated precoding vector/matrix per component carrier. This approach may result in a slight redundancy in RI indication. Rank may be signaled individually while PMI signals the precoder index within the associated rank. However, when the number of precoders per rank is not the same, as with the above approach, the required number of bits may be determined by a worst case scenario. In another approach, a single PMI and a single RI may be employed over all component carriers. The RI is jointly coded with the PMI, wherein the PMI indicates the rank and the associated precoding vector/matrix per component carrier. This approach may be best employed in situations where there exists some rank commonality across component carriers within the same segment of bandwidth.

According to certain aspects, a single PMI and a single RI may also be commonly signaled across all component carriers, and subsequently a “delta” PMI and RI may be signaled for component carriers preferring a differing PMI and RI.

It is contemplated that a MIMO system in the uplink may employ two or more of the described approaches. An AT may be configured (via layer 3) or indicated (via layer 2) with at least one approach for an uplink transmission. The configurations and indications may be semi-static or dynamic, and may be UE-specific and cell-specific.

Non-codebook precoding may be employed for a system using a time division duplex (TDD) scheme. A PMI may not be signaled expressly in downlink control information (DCI). Rather, assuming channel reciprocity in TDD, an AP can perform channel estimation and demodulation based on unprecoded reference signals (RS) from an AT.

It is acknowledged that a precoder used by a DCI transmission from an AT may be different from a precoder that may be preferred by an AP. This discrepancy may come from different channel estimation from both AP and AT due to channel variation, to the channel estimation algorithm, and to the difference in the reference signal used to perform the channel estimation.

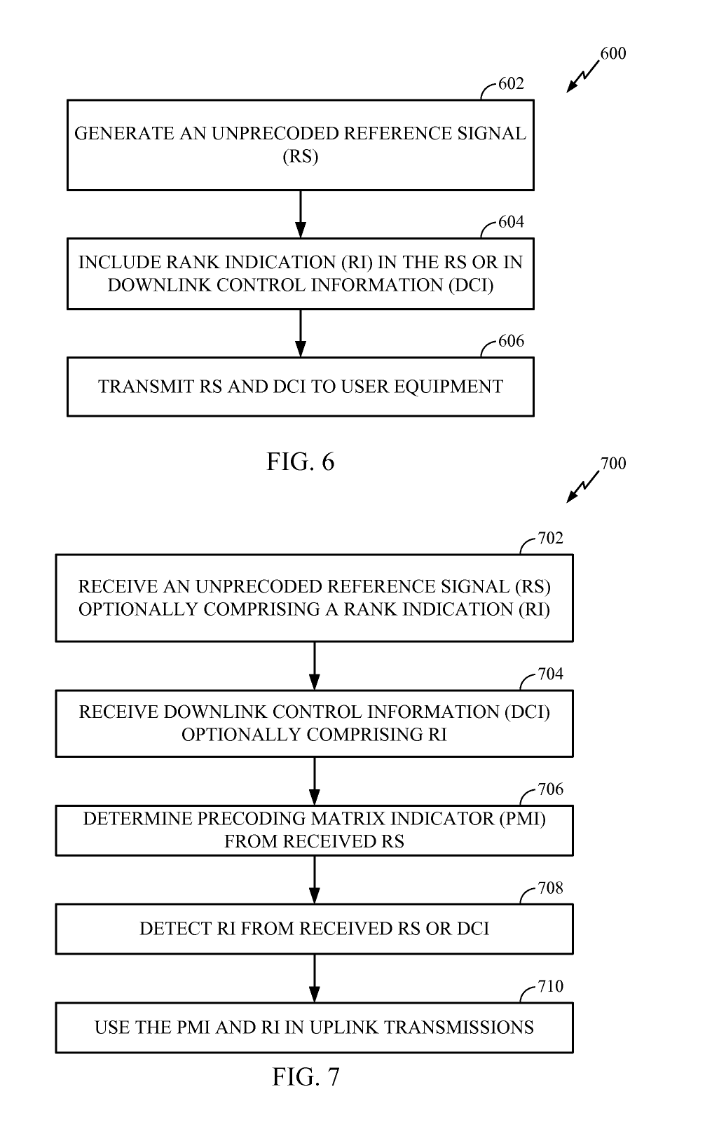

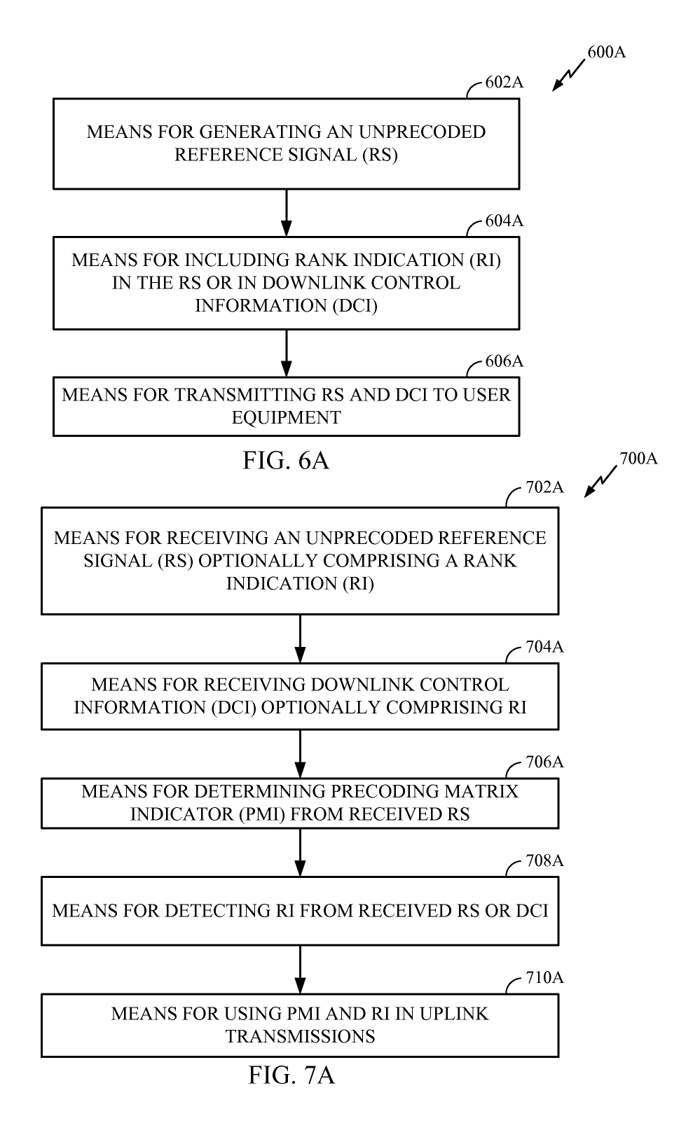

FIG. 6 illustrates example operations 600 that may be performed at an AP for communicating signaling to an AT for uplink transmissions in accordance with certain aspects of the present disclosure. At 602, an AP may generate an unprecoded RS. At 604, the AP may include a RI in the RS or in the DCI. At 606, the AP may transmit the RS and DCI to an AT. In one aspect, the AP may transmit the RS and DCI through any suitable means, for example, through a control channel.

FIG. 7 illustrates example operations 700 that may be performed at an AT for communicating signaling for uplink transmission in accordance with certain aspects of the present disclosure. At 702, an AT may receive an unprecoded RS optionally comprising a RI. At 704, the AT may receive DCI, the DCI also optionally comprising RI. At 706, the AT may determine a PMI from the received RS. According to certain aspects, the AT may determine a PMI by deriving the PMI from the received RS based on channel reciprocity. At 708, the AT may detect RI from at least one of the received RS or the received DCI. At 710, the AT utilizes the PMI and the RI for uplink transmissions.

Unlike PMI, which may not be signaled in uplink DCI formats, a RI may either be explicitly signaled in the DCI, or may be signaled together with the PMI and subsequently estimated from an unprecoded RS. In one aspect, RI is explicitly signaled in DCI format. Based on the signaled RI, an AT may find a preferred precoder and transmit UL based on the preferred precoder. In another aspect, an AP may estimate a RI based on a received unprecoded RS.

According to certain aspects, RI estimation may be combined with “blind” RI detection. An AP may employ a range of candidate estimated RIs to attempt to decode an uplink data transmission assuming each candidate estimated RI as a hypothesis. An AP may store logarithm of likelihood ratios (LLRs) for possible RI for each transmission until the packet decodes the transmission or a maximum number of transmission is reached. This approach may incur a degree of complexity due to managing buffers for LLRs. The AP and AT may also agree upon a transport block size (TBS) based on a RI, number of resource block assignments, and a modulation and coding scheme (MCS). According to one aspect, the LTE Rel-8 TBS table may be employed. It is acknowledged that employing RI estimation and blind detection may affect PHICH. Without bundling of ACK/NACK, an AP may need to send an ACK for each codeword and the number of codewords may depend on the RI. According to one aspect, the AP may send ACK/NACKs based on the possible largest RI. An AT may choose to decode the ACK/NACK based on its transmitted RI. It is acknowledged this may result in an overhead increase in the PHICH resource. With the bundling of ACK/NACK, a single ACK/NACK may be sufficient regardless of the RI.

According to certain aspects, UE-specific RS may be utilized for DL in support of more transmitter antennas without incurring overwhelming overhead on the RS. When employing UE-specific RS, the PMI is not required to be explicitly signaled in DL DCI format, but it may be, as in LTE Rel-8. Rank indication may be signaled or indicated similarly as discussed above with regards to unprecoded RS.

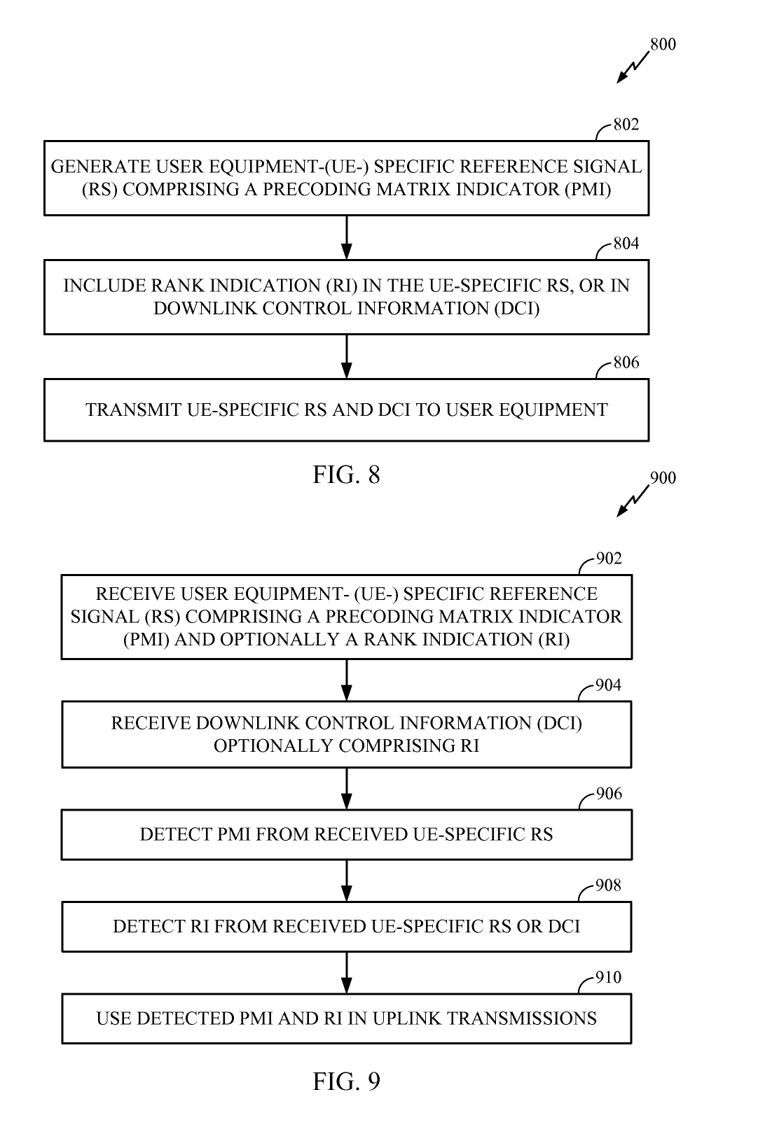

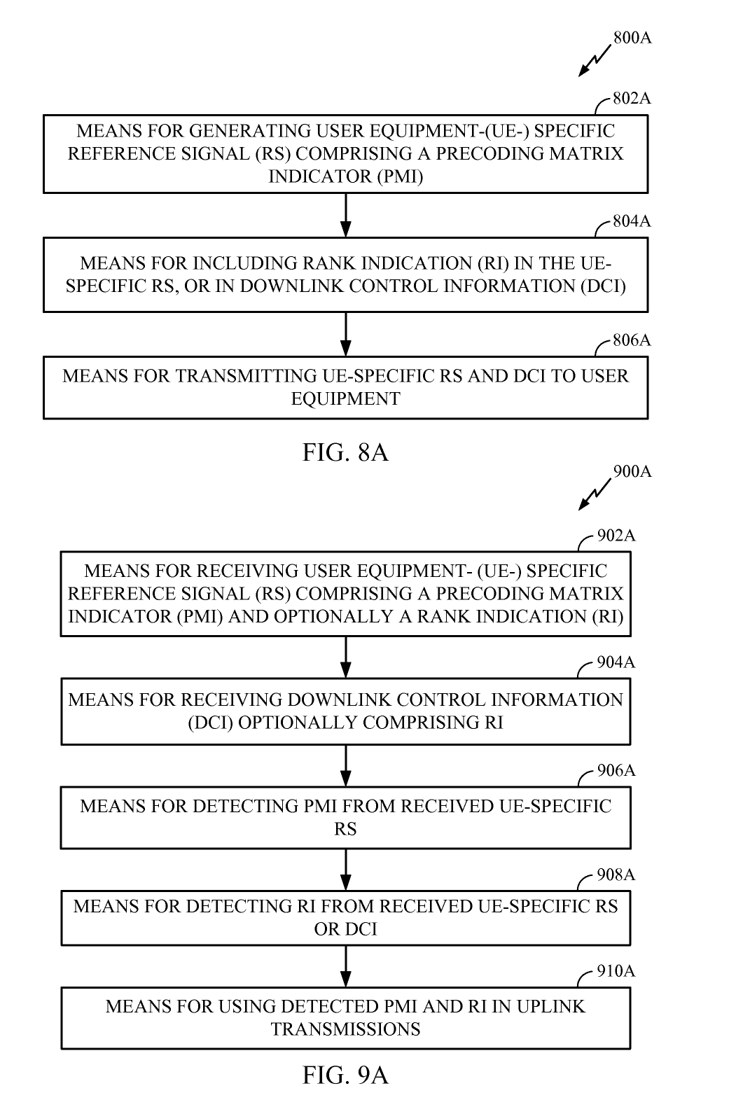

FIG. 8 illustrates example operations 800 that may be performed at an AP for communicating signaling in accordance with certain aspects of the present disclosure. At 802, an AP may generate UE-specific reference signal (RS) comprising a PMI. At 804, the AP may include RI in the UE-specific RS or in the DCI. At 806, the AP may transmit the UE-specific RS and DCI to an AT.

FIG. 9 illustrates example operations 900 that may be performed at an AT for communicating signaling in accordance with certain aspects of the present disclosure. At 902, an AT may receive UE-specific RS comprising a PMI and optionally a RI. At 904, the AT may receive DCI optionally comprising RI. At 906, the AT may detect PMI from the received UE-specific RS. At 908, the AT may detect RI from the received UE-specific RS or from the DCI. At 910, the AT may use the detected PMI and RI in uplink transmission.

According to certain aspects, RI may be explicitly signaled in DCI format. In another aspect, the RI may be estimated from precoded UE-specific RS. The AT detects the RI based on the received UE-specific RS, though this estimation may be noisy. As discussed similarly with regards to unprecoded RS, the RI estimation may be combined with “blind” RI detection, wherein the AT attempts to decode the PDSCH using each candidate estimated RI. The blind RI detection may similarly incur complexity in LLR buffer management by needing to store LLRs for each possible RI for each transmission until the received data is decoded or until the maximum number of transmissions has been reached. The uplink ACK/NACK is also affected due to RI estimation and blind detection. Without ACK/NACK bundling, an ACK may be sent for each codeword and the number of codewords depends on the TRI. According to one aspect, an ACK/NACK may be sent based on the possible largest RI. The AP may choose to decode the ACK/NACK based on its transmitted RI. In one aspect, the AT may send the NACK using format 2b, while the AP may attempt to decode using format 2a. There may be potential performance degradation in ACK/NACK. With ACK/NACK bundling, a single ACK/NACK may suffice regardless of the RI.

It is contemplated that the approaches discussed above may raise additional issues in situations needing retransmissions or a semi-persistent schedule (SPS) of transmissions. In one specific example, in situations where an AP may expect frequent transmission of regular size (such as in voice communications), sending control channel information each time may be wasteful. In such situations, different options may be available.

According to certain aspects, in situations where physical downlink control channel (PDCCH) transmissions are sent for a particular transmission, and when the RI and/or PMI are explicitly signaled, an AT may employ the RI and/or PMI. If the transmission being decoded is the initial transmission, the AT may determine the TBS from the TBS table. If the transmission being decoded is a retransmission, the AT may follow the RI and PMI in the PDCCH, but may use the same TBS as the one indicated in the initial transmission.

According to the certain aspects, in situations where PDCCH is not sent for a particular transmission (i.e. non-adaptive re-transmission), and if the RI is explicitly signaled in the latest PDCCH, the AT may follow a RI signaled in the latest PDCCH. A PMI may be detected based on a current demodulated reference signal (DM-RS). According to certain aspects, if the RI and/or PMI are not explicitly signaled in the latest PDCCH, the AT may detect a RI and/or PMI from a current DM-RS. It is acknowledged in such situations that the RI and/or PMI may change from one transmission to another.

It is also contemplated that the signaling of RI and PMI as discussed above may also impact space division multiple access (SDMA) operations in the UL. According to certain aspects, if a RI and PMI are signaled in the PDCCH, an AT may follow the signaling and it may not be aware whether they are in an SDMA mode. If the RI is signaled but the PMI is not, as may occur with non-codebook based precoding, SDMA ATs may choose a similar PMI, resulting in severe interference. If neither RI nor PMI are signaled, SDMA ATs may choose a similar PMI, resulting in severe interference, and SDMA ATs may choose a RI based on its own channel condition, which may not be supportable when other ATs are also scheduled on the same set of resource blocks. This issue could be partially alleviated by limiting the maximum RI for SDMA users.

The various operations of methods described above may be performed by any suitable means capable of performing the corresponding functions. The means may include various hardware and/or software component(s) and/or module(s), including, but not limited to a circuit, an application specific integrate circuit (ASIC), or processor. Generally, where there are operations illustrated in Figures, those operations may have corresponding counterpart means-plus-function components with similar numbering. For example, blocks 402-404 illustrated in FIG. 4 correspond to means-plus-function blocks 402A-404A illustrated in FIG. 4A.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

1. A method for communicating signaling for uplink transmissions, comprising:
jointly coding at least one rank indication (RI) and at least one precoding matrix indicator (PMI) using a codebook; and
transmitting the jointly encoded RI and PMI to an access terminal.

2. The method of claim 1, wherein the RI is jointly coded with the PMI on a per component carrier basis.

3. The method of claim 1, wherein jointly coding further comprises jointly encoding a plurality of PMI and the RI on a per component carrier basis.

4. A method for communicating signaling for uplink transmissions, comprising:
receiving a jointly encoded rank indication (RI) and a precoding matrix indicator (PMI);
decoding the jointly encoded RI and PMI using a codebook to determine a RI and a PMI; and
using the determined RI and PMI in uplink transmissions.

5. The method of claim 4, wherein the determined RI and PMI comprises a plurality of PMI per component carrier and at least one RI per component carrier.

6. An apparatus for wireless communications, comprising:
logic for jointly coding at least one rank indication (RI) and at least one precoding matrix indicator (PMI) using a codebook; and
logic for transmitting the jointly encoded RI and PMI to an access terminal.

7. The apparatus of claim 6, wherein the RI is jointly coded with the PMI on a per component carrier basis.

8. The apparatus of claim 6, wherein the logic for jointly coding further comprises logic for jointly encoding a plurality of PMI and the RI on a per component carrier basis.

9. An apparatus for wireless communications, comprising:
logic for receiving a jointly encoded rank indication (RI) and a precoding matrix indicator (PMI);
logic for decoding the jointly encoded RI and PMI using a codebook to determine a RI and a PMI; and
logic for using the determined RI and PMI in uplink transmissions.

10. The apparatus of claim 9, wherein the determined RI and PMI comprises a plurality of PMI per component carrier and at least one RI per component carrier.

11. An apparatus for wireless communications, comprising:
means for jointly coding at least one rank indication (RI) and at least one precoding matrix indicator (PMI) using a codebook; and
means for transmitting the jointly encoded RI and PMI to an access terminal.

12. The apparatus of claim 11, wherein the RI is jointly coded with the PMI on a per component carrier basis.

13. The apparatus of claim 11, wherein the means for jointly coding further comprises means for jointly encoding a plurality of PMI and the RI on a per component carrier basis.

14. An apparatus for wireless communications, comprising:
means for receiving a jointly encoded rank indication (RI) and a precoding matrix indicator (PMI);
means for decoding the jointly encoded RI and PMI using a codebook to determine a RI and a PMI; and
means for using the determined RI and PMI in uplink transmissions.

15. The apparatus of claim 14, wherein the determined RI and PMI comprises:
means for a plurality of PMI per component carrier and at least one RI per component carrier.

16. A computer-program product for wireless communications, comprising a computer readable medium having instructions stored thereon, the instructions being executable by one or more processors and the instructions comprising:
instructions for jointly coding at least one rank indication (RI) and at least one precoding matrix indicator (PMI) using a codebook; and
instructions for transmitting the jointly encoded RI and PMI to an access terminal.

17. The computer-program product of claim 16, wherein the RI is jointly coded with the PMI on a per component carrier basis.

18. The computer-program product of claim 16, wherein the instructions for jointly coding further comprises instructions for jointly encoding a plurality of PMI and the RI on a per component carrier basis.

19. A computer-program product for wireless communications, comprising a computer readable medium having instructions stored thereon, the instructions being executable by one or more processors and the instructions comprising:
instructions for receiving a jointly encoded rank indication (RI) and a precoding matrix indicator (PMI);
instructions for decoding the jointly encoded RI and PMI using a codebook to determine a RI and a PMI; and
instructions for using the determined RI and PMI in uplink transmissions.

20. The computer-program product of claim 19, wherein the determined RI and PMI comprises a plurality of PMI per component carrier and at least one RI per component carrier.

21. An apparatus for wireless communications, comprising:
at least one processor configured to:
jointly code at least one rank indication (RI) and at least one precoding matrix indicator (PMI) using a codebook, and
transmit the jointly encoded RI and PMI to an access terminal; and
a memory coupled to the at least one processor.

22. The apparatus of claim 21, wherein the RI is jointly coded with the PMI on a per component carrier basis.

23. The apparatus of claim 21, wherein jointly code further comprises jointly encoding a plurality of PMI and the RI on a per component carrier basis.

24. An apparatus for wireless communications, comprising:
at least one processor configured to:
receive a jointly encoded rank indication (RI) and a precoding matrix indicator (PMI),
decode the jointly encoded RI and PMI using a codebook to determine a RI and a PMI, and
use the determined RI and PMI in uplink transmissions; and
a memory coupled to the at least one processor.

25. The apparatus of claim 24, wherein the determined RI and PMI comprises a plurality of PMI per component carrier and at least one RI per component carrier.
